(19) United States
(12) Patent Application Publication
(10) Pub. No.: US 2025/0111519 A1
(43) Pub. Date: Apr. 3, 2025

(54) INSTANCE SEGMENTATION USING OVERLAPPING TILES AND OVERLAP HANDLING

(71) Applicant: Carl Zeiss Microscopy GmbH, Jena (DE)

(72) Inventors: Simon FRANCHINI, München (DE); Sebastian SOYER, München (DE); Sandra LEMKE, München (DE); Raphael DIAS-MONTEIRO, Rostock (DE); Tomaz BELCIJAN, Rostock (DE); Emil NOWOSIELSKI, Rostock (DE); Jerzy KOWALSKI, Rostock (DE); Mohamed Yassine ELKHADIRI, Soukra (TN)

(73) Assignee: Carl Zeiss Microscopy GmbH, Jena (DE)

(21) Appl. No.: 18/899,097

(22) Filed: Sep. 27, 2024

(30) Foreign Application Priority Data
Sep. 29, 2023 (DE) 102023126724.8

(51) Int. Cl. G06T 7/12; G06T 7/11; G06T 7/13

(52) U.S. Cl. CPC G06T 7/12; G06T 7/11; G06T 7/13; G06T 2207/10056

(57) ABSTRACT

An image is broken down into multiple tiles pairs of the tiles include an overlap region. The tiles can be processed by a instance segmentation algorithm. Techniques of overlap handling of multiple instance boundaries at least partly arranged in the overlap region are disclosed.

### FIELD OF THE INVENTION

Various embodiments relate to techniques for instance segmentation of multiple instances of objects in images. Various examples specifically relate to instance segmentation using a tile-based instance segmentation algorithm. Various examples pertain specifically to overlap handling of instances of an object segmented in overlap regions between neighboring tiles.

### BACKGROUND OF THE INVENTION

Instance segmentation is a computer vision task that involves identifying and separating individual instances of objects within an image, including detecting the boundaries of each instance of the objects, and assigning a unique label to each instance of the objects. Unlike semantic segmentation, instance segmentation discriminates between individual instances of objects of the same class.

Various types of instance segmentation algorithms are known in the art. For example, techniques are known to perform instance segmentation using machine-learning models. Machine-learning models are used to implement instance segmentation algorithms. An example of a machine-learning model is a neural network.

FIG. 1 schematically illustrates an exemplary architecture 1000 of neural networks for instance segmentation according to the prior art. The architecture 1000 was introduced in a non-patent literature—He, Kaiming, et al. “Mask R-CNN.” Proceedings of the IEEE international conference on computer vision. 2017, which was named as Mask Region-based Convolutional Neural Network (Mask R-CNN). The Mask R-CNN, i.e., the architecture 1000 of FIG. 1, allows for the identification of discrete objects, e.g., football players, in an input image 1010. The Mask R-CNN can detect football players and provide masks 1030 which respectively cover each instance of a football player. The masks 1030 respectively have boundaries surrounding/enclosing individual instances of the object. The masks can, accordingly, be referred to as “instance boundary”.

The Mask R-CNN has a branch for predicting segmentation masks 1030 on each Region of Interest (Rol) 1040, in parallel with branches respectively for classification and bounding box regression. The mask branch is a Fully Convolutional Network (FCN) applied to each Rol 1040, predicting a segmentation mask 1030 in a pixel-to-pixel manner. To establish pixel-to-pixel alignment between the network input, e.g., image 1010, and the network output, e.g., image 1020, the Mask R-CNN comprises a simple, quantization-free layer, called “RolAlign”, which can preserve exact spatial locations.

Instance segmentation algorithms such as the Mask R-CNN are oftentimes developed to operate based on datasets of everyday images. Such images may be captured by mobile phone cameras and have relatively smaller file sizes; this limited resolution enables the images to be processed directly and entirely by conventional instance segmentation algorithms. This is done by feeding them through the instance segmentation algorithm, which is executed on a computing processor, e.g., a Graphics Processing Unit (GPU). For example, a single forward pass through an instance segmentation neural network may be performed. An example of a frequently used dataset to develop instance segmentation algorithms is the coco dataset (See: https://cocodataset.org/; retrieved Sep. 19, 2023).

However, the analysis of large images, such as microscopy images or satellite images, by the conventional instance segmentation algorithms can be challenging. Large images can have tens or hundreds of gigapixels. Such large images can be obtained, e.g., from stitching together multiple individual images.

The larger the image being analyzed or processed, the more compute memory is required to run an instance segmentation algorithm. Because compute memory—in particular Graphics Processing Unit (GPU) memory—is expensive and limited, large images cannot be processed in a routine way using existing instance segmentation algorithms, e.g., in a single forward pass. Herein, techniques for instance segmentation of multiple instances of objects in images will be described in connection with “forward pass” as an exemplary procedure for performing instance segmentation.

To mitigate such problems of limited compute resources, the image can be broken down into tiles (sometimes also referred to as subsections or patches). Each tile is processed, e.g., in a separate forward pass, in the instance segmentation algorithm. Then the results of each forward-pass are reassembled after the instance segmentation is performed.

For instance, non-patent literature—Payer, Christian, et al. “Segmenting and tracking cell instances with cosine embeddings and recurrent hourglass networks.” Medical image analysis 57 (2019): 106-119.—proposes a novel recurrent fully convolutional network architecture. Overlap handling for predicting instances of an object in overlapping tiles is disclosed. The respective merging strategy includes the following steps: instances touching the border of a tile are removed, as long as the border is not an outer border of the whole image; and if instances are predicted by multiple tiles, the instances with the largest area are taken. Such approach faces certain restrictions and drawbacks. The segmentation map of an entire image cannot be precisely and reliably obtained using such prior art implementations. It is not possible to implement instance segmentation for objects of arbitrary size.

### SUMMARY OF THE INVENTION

There is a need for advanced techniques of instance segmentation. In particular, there is a need for techniques which allow accurate and/or reliable instance segmentation of large-size images. Instance segmentation of objects of arbitrary size is required.

Various examples are concerned with tile-wise processing of an image in an instance segmentation algorithm. Various examples are specifically concerned with overlap handling: For pairs of overlapping tiles, there are regions of the image that are processed multiple times (overlap regions). These overlap regions belong to pairs of neighboring tiles. Results of the instance segmentation algorithm in these overlap regions are consolidated and merged. In these overlap regions, there can be conflicts, e.g., different instance segmentation results for different tiles. Such conflicts are accurately resolved in accordance with the disclosed techniques.

A computer-implemented method includes obtaining an image. The image depicts a plurality of instances of an object.

For instance, a microscopy image may be obtained. A light microscopy image or scanning-electron image may be obtained. A satellite image may be obtained. The image may have a particular large count of pixels. For instance, the image can have more than E5 pixels.

The object may pertain to certain semantic features depicted multiple times in the image, e.g., a cell, a certain cell type, a semiconductor structure, a semiconductor structure defect, a house, a housing type, a street, a street type, etc. An instance of an object pertains to a specific occurrence of that object in the image.

The method includes breaking down the image into multiple tiles. Tiles may also be referred to as patches. The image may be, accordingly, be titled. Pairs of the neighboring tiles of the multiple tiles include respective overlap regions. In other words, the tiling process uses a stride size that is smaller than the tile size. This generates the overlap regions.

The method further includes processing the multiple tiles using an instance segmentation algorithm. Various types of instance segmentation algorithms can be used including machine-learned instance segmentation algorithms. One example would be the Mask R-CNN instance segmentation algorithm, see He, Kaiming, et al. “Mask r-cnn.” Proceedings of the IEEE international conference on computer vision. 2017.

The instance segmentation algorithm provides, as an output, instance boundaries for the plurality of instances of the object. Each instance of the object is associated with a respective instance boundary. Thereby, different instances are discriminated against each other. Instance boundaries can be implemented by, e.g., bounding boxes, lines (e.g., polygons or splines) delineating an outer circumference of each instance, or an instance segmentation map, to give just a few examples.

The method includes for each of the pairs of neighboring tiles and for each instance boundary truncated by a board of a tile of the respective pair: merging or not merging (selectively merging) the respective instance boundary truncated by the board of the tire with the further instance boundary positioned in a further title of the respective pair. Such selectively merging depends on an overlap degree between the respective instance boundary truncated by the board of the tile and the further instance boundary.

As a general rule, different metrics for the overlap degree are conceivable. For instance, an area-wise overlap can be determined. This means that the size of the intersection of the areas covered by a first instance and a second instance can be proportional to the overlap degree. This may be modified or replaced in some instances with a shape-based metric, e.g., considering a shape of the contours. For instance, two circular objects may have a larger overlap degree than a circular and a rectangular object.

Sometimes, the metric of the overlap degree may be user configurable. It would also be possible to select the metric for determining the overlap degree depending on a semantic content of the image. For instance, it may be appropriate to use a different metrics to determine the overlap degree for microscopic images depicting cells if compared to microscopic images that depict semiconductor structures. This is because semiconductor structures are typically exhibiting a regular appearance while cells have arbitrary, non-regular shapes. Similar considerations may apply to, e.g., satellite images of residential areas (e.g., analyzed to determine a building density) if compared to satellite images of forests (e.g., analyzed for quantifying a vegetation density).

As a general rule, the overlap degree may be restricted to the overlap region. This means that fractions of the instances of an object extending outside of the overlap region may not be considered. This is based on the finding that in particular for objects of arbitrary shape the overlap degree should be determined for regions in which multiple measures for the instance segmentation are available, i.e., only within the overlap region.

As a general rule, merging may be only executed if the overlap degree is indicative of a particular high degree of overlap.

Then, a situation can occur in which two overlapping instances are not associated with a particularly high overlap degree for instance, two instances may barely overlap and have a very small intersection. In such a scenario, it is possible that one of the two overlapping instances is discarded/removed while the other one is retained. As a general rule, discarding or removing an instance can pertain to permanently deleting that instance so that the final segmentation result does not include the removed instance.

Various examples disclosed herein pertain to the selection logic which of two overlapping instances having is removed (e.g., if they are not merged). Such decision can be based on various criteria including, but not limited to: randomize selection; confidence value; size of the instance boundaries; surrounding; etc. This is exemplified hereinafter: the instance segmentation algorithm can provide instance boundaries with different confidence/trustworthiness. It is then possible to compare the confidence values. For example, such instance boundaries having particularly low confidence values associated therewith may be primarily discarded. Sometimes, the area covered by an instance boundary may be a measure of its confidence. As a general rule, it would be possible to preferably discard small instance boundaries, i.e., such instance boundaries that enclose a small area. It would be possible to preferably discard instance boundaries that have a small area to surface ratio. It would also be possible to take into account a surrounding of each instance boundary. For instance, scenarios are conceivable in which instance boundaries having a densely populated surrounding, i.e., many other instances in the close neighborhood, are considered to be less reliable and thus preferably discarded.

For instance, it would be possible to selectively merge two instance boundaries with each other upon determining that their overlap degree is above a predefined first threshold; and to remove one of the two overlapping instance boundaries upon determining that the overlap is below the first predefined threshold, but is above the second predefined threshold. Thus, a multi-threshold comparison may be executed.

For an overlap degree even below the second predefined threshold, both instances can be retained.

In some examples, after merging and/or removing all instances having a certain overlap, a postprocessing for artifact removal may be applied. I.e., based on certain predefined criteria, it can be determined whether certain instances correspond to spurious artifacts. For instance, shape-based artifact detection metrics can be employed. It would be possible to apply machine-learning models to identify artifacts. Artifacts can then be retrospectively removed.

Above, techniques of overlap handling for a tiling process that produces tiles that have overlap regions have been disclosed. The overlap handling techniques produce instance boundaries for each tile with consolidated outputs in the overlap region. As a final step, it is possible to merge the instance boundaries of all tiles to provide a finer instance segmentation result for the overall image. For instance, an instance segmentation map for the final image can be provided.

Such image-level instance segmentation result can facilitate various use cases. For instance, instances can be counted. A filling fraction of instances can be determined. Instances of multiple objects types can be compared with each other. Semantic labeling of an image is possible. The image level instance segmentation result can be output via a graphical user interface. Automated postprocessing is also possible.

Some concrete use cases are explained next. Medical Diagnostics: In pathology, instance segmentation can help identify and segment individual cells in tissue samples, aiding in the diagnosis of disease. Drug discovery: Researchers use instance segmentation to monitor cell responses to different drug treatments, which is critical for drug development and understanding cell dynamics. Agriculture: Instance segmentation can be used to identify and count individual trees or plants in a field to assess health, productivity, or monitor growth patterns. Urban Planning and Land Use Classification: City planners and environmentalists use instance segmentation to identify individual buildings, roads, parks, and other infrastructure to aid in urban planning and environmental impact studies. Defect Detection in Manufacturing: In electronics, SEM images are processed using instance segmentation to identify individual components or defects at a detailed level to ensure product quality. Traffic Management and Monitoring: Instance segmentation can differentiate and count individual vehicles on roads, aiding traffic flow analysis and congestion prediction. Retail and Inventory Management: Store cameras with instance segmentation can identify and count individual products on shelves, aiding inventory management and replenishment. Biodiversity monitoring: Ecologists use instance segmentation in satellite and drone imagery to count individual animals in a herd or monitor vegetation types, critical for conservation efforts. Materials Science: Researchers use SEM images and instance segmentation to segment individual particles, fibers, or phases in materials, helping to understand material properties and behavior. Archaeology and Heritage Preservation: Archaeologists use instance segmentation in satellite imagery to identify potential archaeological sites or individual structures and artifacts, guiding excavation efforts or cultural heritage preservation.

It is to be understood that the features mentioned above and those yet to be explained below may be used not only in the respective combinations indicated but also in other combinations or in isolation without departing from the scope of the invention.

### BRIEF DESCRIPTION OF THE DRAWINGS

FIG. 1 schematically illustrates an exemplary architecture of neural networks for instance segmentation according to the prior art.

FIG. 2 schematically illustrates an exemplary image divided into multiple tiles according to various examples.

FIG. 3 schematically illustrates an exemplary pair of neighboring tiles of an image according to various examples.

FIG. 4 is a flowchart of a method according to various examples.

FIG. 5 schematically illustrates respective binary masks of two instance boundaries located in an overlap region of the exemplary pair of neighboring tiles of FIG. 3.

FIG. 6 is a block diagram of a computing device according to various examples.

FIG. 7 is a flowchart of a method according to various examples.

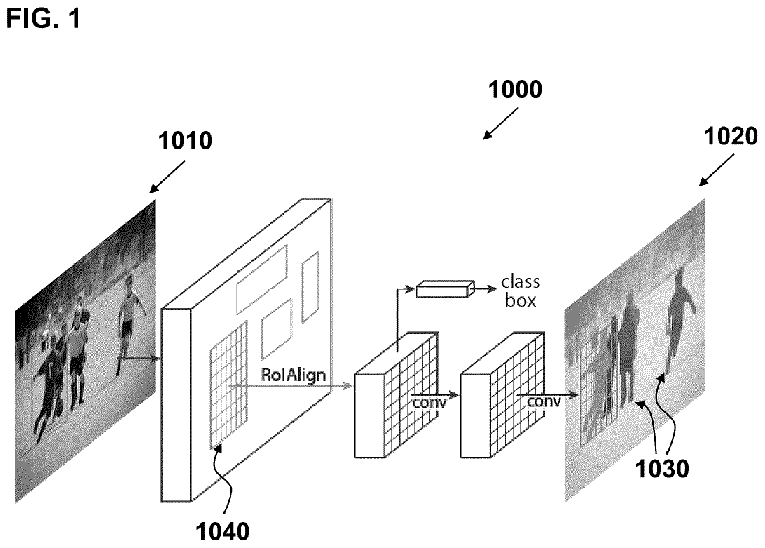

### DETAILED DESCRIPTION OF THE INVENTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, machine-learning-specific hardware, e.g., a graphics processor unit (GPU) and/or a tensor processing unit (TPU), integrated circuits, memory devices (e.g. FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a set of program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings, which are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various techniques described herein generally relate to instance segmentation. Instance segmentation is used to determine instance boundaries for each instance of an object. Instance boundaries can be formed by bounding boxes or an outline delineating borders of each instance of an object. A pixel-wise segmentation map can be provided, assigning each pixel to either a specific object instance (or background, or other instances of other object types). The segmentation map can accordingly include a collection of multiple instance boundaries.

Instance segmentation is a special form of image segmentation that deals with detecting instances of objects and demarcating their boundaries. One way in which a boundary of the instance (instance boundary) of an object can be described is by assigning pixels of the image to instances of objects.

Also, overlapping instances of an object or multiple objects may be determined in some examples.

Unlike semantic segmentation, instance segmentation discriminates between individual instances of objects of the same class. For example, if two instances of an object are present in an image, instance segmentation will identify them as two separate instances.

Instance segmentation can optionally discriminate between different types of objects; however, this is not germane for the techniques disclosed herein.

There are various instance segmentation algorithms available before the filing of this application, which can be used herein for processing multiple tiles of a single large-size image depicting a plurality of instances of one or more objects. For example, existing instance segmentation algorithms may comprise corresponding algorithms disclosed and/or referred to in the following non-patent literature:

Ke, Lei, Yu-Wing Tai, and Chi-Keung Tang. “Deep occlusion-aware instance segmentation with overlapping bilayers.” Proceedings of the IEEE/CVF conference on computer vision and pattern recognition. 2021.

He, Kaiming, et al. “Mask R-CNN.” Proceedings of the IEEE international conference on computer vision. 2017

Chen, Kai, et al. “MMDetection: Open mmlab detection toolbox and benchmark.” arXiv preprint arXiv:1906.07155 (2019).

Bolya, Daniel, et al. “Yolact: Real-time instance segmentation.” Proceedings of the IEEE/CVF international conference on computer vision. 2019.

According to various examples, a machine-learning model may be used for instance segmentation. The machine-learning model may be pre-trained. A Mask-R-CNN may be used.

The particular type of instance segmentation algorithm is not germane for the techniques disclosed herein. The techniques disclosed herein can cooperate with various types of instance segmentation algorithms.

The techniques disclosed herein enable efficient processing of large-scale images. Tile-wise processing is employed. Tile-wise processing, also sometimes referred to as “patch-based” processing, involves breaking down a larger image into smaller tiles (or patches) and processing these tiles independently before combining the results to generate a complete output for the entire image.

According to various examples, to circumvent scaling down image data of large-size images, each of such images may be split into multiple tiles of suitable resolution such as 256*256 pixels, 480*480 pixels, 512*512 pixels, 720*720 pixels, 1280*720 pixels and so on, complying with the input size of available or existing instance segmentation models or algorithms.

Various tiling approaches can be used to break a large-size image into multiple tiles so that pairs of neighboring tiles comprise respective overlap regions. For example, the large-size image can be covered by a sliding window approach, using a fixed stride of a specific count of pixels, e.g., 128, 256, etc. This approach places a tile at an overlap with each adjacent tile in the x-axis (or horizontal) direction as well as in the y-axis (or vertical) direction. For example, if the size of a tile is 512*512 pixels and the fixed stride is 128 pixels, this approach will place a tile at an overlap of 25% with each adjacent tile in the x-axis direction as well as in the y-axis direction.

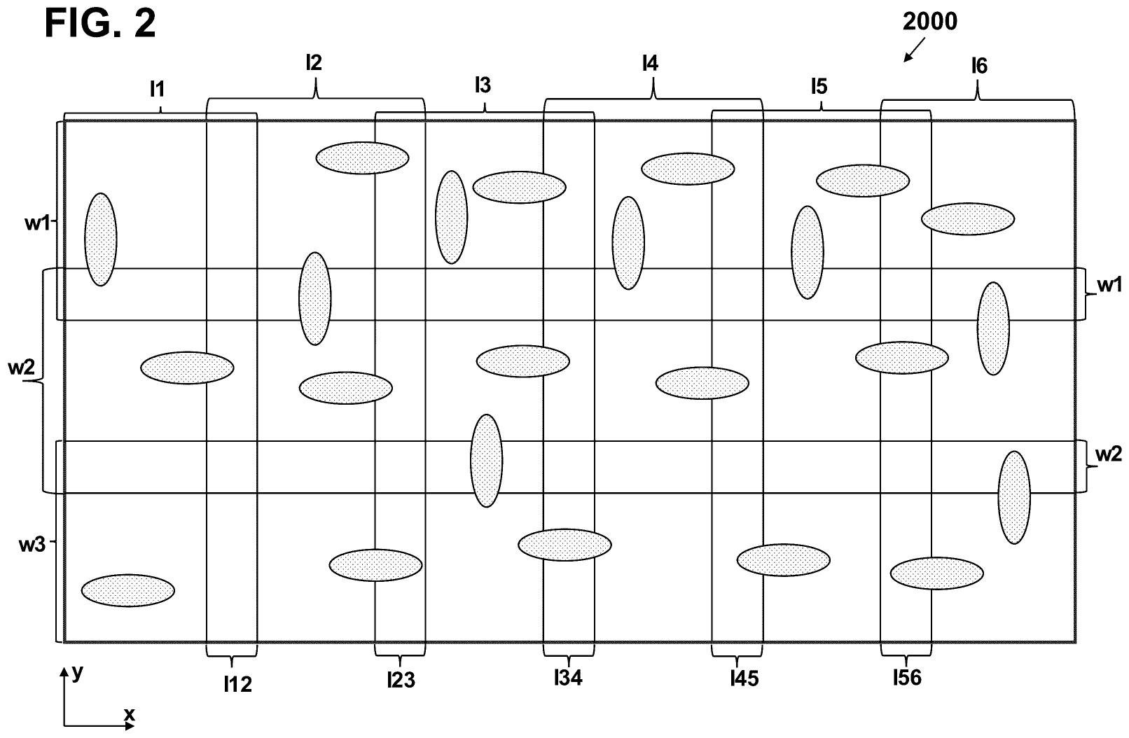

FIG. 2 schematically illustrates an exemplary two-dimensional image 2000 divided or split into multiple tiles according to various examples. The image 2000 may be broken down into multiple tiles along the x-axis and y-axis, respectively. For example, as shown in FIG. 2, the image 2000 is broken down into 3 rows along the y-axis (also defined as width herein), and 6 columns along the x-axis (also defined as length herein), i.e., in total 18 tiles. The 18 tiles respectively have width-length value pairs (w1, I1), (w1, I2), . . . , (w3, I5), and (w3, I6) and will be indicated as tile (w1, I1), tile (w1, I2), . . . , tile (w3, I5), and tile (w3, I6) hereinafter, respectively. The image 2000 comprises multiple pairs of neighboring tiles and each pair of the multiple pairs comprises an overlap region. Similar to the tiles, the respective overlap regions between pairs of neighboring tiles along the x-axis are also indicated using width-length value pairs, i.e., overlap region (w1, I12), overlap region (w1, I23), . . . , overlap region (w2, I12), overlap region (w2, I23), . . . , overlap region (w3, I45), and overlap region (w3, I56), and the respective overlap regions between pairs of neighboring tiles along the y-axis are also indicated using width-length value pairs, i.e., overlap region (w12, I1), overlap region (w12, I2), . . . , overlap region (w23, I1), overlap region (w23, I2), . . . , and overlap region (w23, I6). For example, in the row of tiles sharing the same width w1, the image 2000 comprises 5 pairs of neighboring tiles along the x-axis, i.e., pair [tile (w1, I1), tile (w1, I2)] comprising the overlap region (w1, I12), pair [tile (w1, I2), tile (w1, I3)] comprising the overlap region (w1, I23), pair [tile (w1, I3), tile (w1, I4)] comprising the overlap region (w1, I34), pair [tile (w1, I4), tile (w1, I5)] comprising the overlap region (w1, I45), and pair [tile (w1, I5), tile (w1, I6)] comprising the overlap region (w1, I56). Similarly, in the columns of tiles sharing the same length I1, the image 2000 comprises 2 pairs of neighboring tiles along the y-axis, i.e., pair [tile (w1, I1), tile (w2, I1)] comprising the overlap region (w12, I1) and pair [tile (w2, I1), tile (w3, I1)] comprising the overlap region (w23, I1). For example, the 18 tiles of the image 2000 may be split or broken down from left to right, top to bottom.

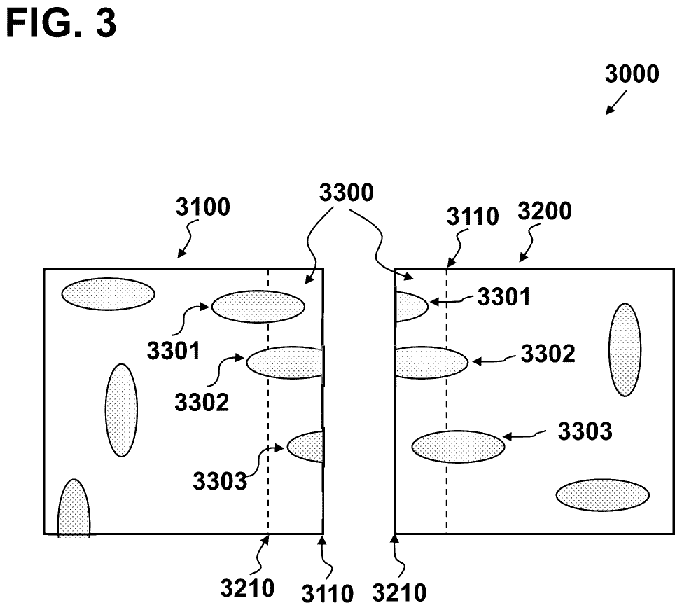

Various techniques disclosed herein are generally based on the findings that the overlap handling and in particular the merging strategy for instance segmentation results in the overlap region disclosed in the non-patent literature—Payer, Christian, et al. “Segmenting and tracking cell instances with cosine embeddings and recurrent hourglass networks.” Medical image analysis 57 (2019): 106-119.—cannot precisely and reliably process or handle objects which have characteristic dimensions larger than the width of the overlap region. For instance, objects that extend throughout an entire overlap region and beyond cannot be precisely processed. This limits the ability of the prior art solution to segment instances of objects of arbitrary size. It has been found that such inaccuracies in the overlap handling are due to larger objects being truncated by the borders of both neighboring tiles and consequently be removed/discarded. This negatively affects the accuracy of the instance segmentation. This finding will be explained in further detail in connection with FIG. 3 below.

FIG. 3 schematically illustrates an exemplary pair 3000 of neighboring tiles of an image according to various examples. For example, the pair 3000 of neighboring tiles may be any pair of tiles of the image 2000 of FIG. 2, e.g., pair [tile (w1, I1), tile (w1, I2)] comprising the overlap region (w1, I12), pair [tile (w1, I2), tile (w1, I3)] comprising the overlap region (w1, I23), pair [tile (w1, I3), tile (w1, I4)] comprising the overlap region (w1, I34). The pair 3000 of neighboring tiles comprises a first tile 3100 and a second tile 3200. The first tile 3100 and the second tile 3200 have an overlap region 3300 between a first border 3110 of the first tile 3100 and a second border 3210 of the second tile 3200. Both the first tile 3100 and the second tile 3200 respectively depict multiple instances of an object, i.e., entire or partial oval shapes filled with a dotted pattern, in which three instances 3301, 3302, and 3303 of the object are respectively truncated by at least one border of the two neighboring tiles 3100 and 3200, i.e., borders 3110 and/or 3210. For example, the instance 3301 is truncated by the second border 3210, the instance 3302 is truncated by both the first border 3110 and the second border 3210, and the instance 3303 is truncated by the first border 3110.

Accordingly, the instances 3301, 3302, 3303 extend beyond the overlap region. The instances 3301, 3302, 3303 have dimensions (e.g., a left-right extension in the example of FIG. 3) that are comparable to the dimensions of the overlap region 3300.

By utilizing the merging strategy disclosed in the non-patent literature—Payer, Christian, et al. “Segmenting and tracking cell instances with cosine embeddings and recurrent hourglass networks.” Medical image analysis 57 (2019): 106-119, respective parts of the instance 3302 depicting in the first tile 3100 and the second tile 3200 are removed, and consequently, the instance 3302 of the object is missing in the segmentation result of the pair 3000 obtained by merging respective segmentation maps of the first tile 3100 and the second tile 3200. This is an undesired behavior. As such, the existing techniques cannot precisely and reliably merge instance segmentation results from individual tiles of large-size images back together, especially when the size of the object is larger than, for example, the width or length of the overlap region.

The techniques disclosed herein mitigate such restrictions and drawbacks. The techniques disclosed herein provide for advanced overlap handling and specifically merging of matching instances of an object.

Hereinafter, techniques that facilitate determining an instance segmentation map of an entire large-size image are described. The image depicts a plurality of instances of an object. For example, the image may be obtained during or after a tiles experiment. The image is broken down (or split) into multiple tiles and pairs of neighboring tiles comprise respective overlap regions. The multiple tiles are processed using an instance segmentation algorithm to obtain respective instance boundaries for the plurality of instances of the object. For each of the pairs of neighboring tiles and for each instance boundary truncated by a border of a tile of the respective pair, the respective instance boundary truncated by the border of the tile is selectively merged with a further instance boundary positioned in a further tile of the respective pair depending on an overlap degree between the respective instance boundary truncated by the border of the tile and the further instance boundary.

According to various examples, the image may comprise microscopy images or satellite images. In a microscopy image, the object may comprise various cells such as muscle cells, neuron cells, bacteria, viruses, etc. In a satellite image, the object may comprise trees, buildings, roads, farms, and so on. Microscopy images may be acquired using light microscopy. Also, charged-particle scanning microscopy can be used, e.g., scanning electron microscopy. For instance, a multi-field of view scanning electron microscopy imaging device can be used that contemporaneously performs multiple raster scans. X-ray images can be investigated. Computed Tomography images can be investigated.

The image may be derived from multiple sub-images stitched together, in which multiple imaging processes are used to acquire image data that is then stitched together to form the image. The image may be obtained either during or after a tiles experiment. The processing of the image, e.g., splitting into tiles and performing instance segmentation, may take place either during or after the tiles experiment, i.e., either real-time processing or post-processing is possible.

As will be appreciated, the disclosed techniques can, in particular, be employed for large-size images, e.g., having more than E5, E9 or E12 pixels. Images in various use cases or test scenarios can be processed.

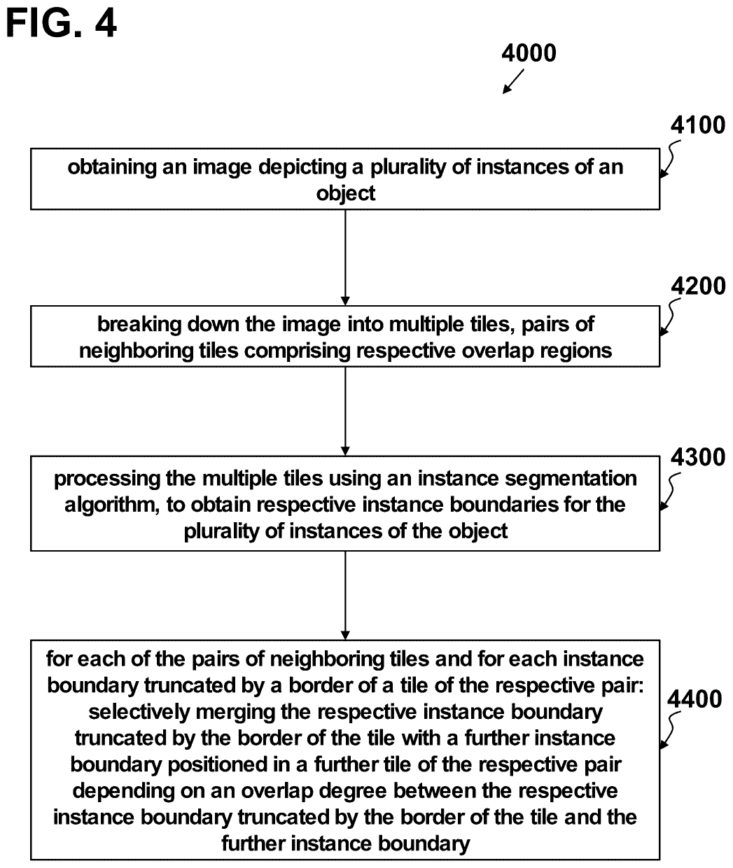

Next, details with respect to the overlap handling and merging of instances of objects detected in overlap regions all paths of neighboring tiles will be explained in connection with FIG. 4.

FIG. 4 is a flowchart of a method 4000 according to various examples. For example, the method 4000 according to FIG. 4 may be executed by at least one circuit—e.g., a central processing unit (CPU) and/or a graphics processing unit (GPU) and/or a tensor processing unit (TPU)—upon loading program code from a nonvolatile memory. The method 4000 of FIG. 4 facilitates instance segmentation of large-size images such as microscopy images or satellite images.

The method 4000 is directed towards aspects of processing an image depicting a plurality of instances of an object. The image is broken down (or split) into multiple tiles and pairs of neighboring tiles comprise respective overlap regions. The multiple tiles are processed using an instance segmentation algorithm to obtain respective instance boundaries for the plurality of instances of the object. For each of the pairs of neighboring tiles and for each instance boundary truncated by a border of a tile of the respective pair, the respective instance boundary truncated by the border of the tile is selectively merged with a further instance boundary positioned in a further tile of the respective pair depending on an overlap degree between the respective instance boundary truncated by the border of the tile and the further instance boundary. Details of the method 4000 are described below.

Block 4100: obtaining an image, e.g., the image 2000 of FIG. 2, depicting a plurality of instances of an object, e.g., the oval shapes filled with a dotted pattern shown in FIG. 2.

For example, the image may be loaded from a memory or obtained via an input interface from a data acquisition unit. The image may be obtained from a microscope, a satellite, or a database storing the image.

Block 4100 may optionally include controlling an image acquisition device to acquire the image.

After obtaining the image, the method 4000 of FIG. 4 may optionally include pre-processing of the image such as noise filtering, cropping borders, etc.

Block 4200: breaking down the image, e.g., the image 2000 of FIG. 2, into multiple tiles, wherein pairs of neighboring tiles comprise respective overlap regions. I.e., the image is broken down into multiple tiles so that pairs of neighboring tiles comprise respective overlap regions.

For example, the image may be broken down (or split) into multiple tiles based on the strategy shown in FIG. 2. Further, it is also possible to apply various tiling approaches disclosed in non-patent literature—Kloster, Michael, et al. “Improving deep learning-based segmentation of diatoms in gigapixel-sized virtual slides by object-based tile positioning and object integrity constraint.” Plos one 18.2 (2023): e0272103. Alternatively, the overlap-tile strategy disclosed in non-patent literature—Ronneberger, Olaf, Philipp Fischer, and Thomas Brox. “U-net: Convolutional networks for biomedical image segmentation.” Medical Image Computing and Computer-Assisted Intervention-MICCAI 2015: 18th International Conference, Munich, Germany, Oct. 5-9, 2015, Proceedings, Part III 18. Springer International Publishing, 2015.—can be utilized as well.

According to various examples, the image may be broken down into multiple tiles with the same size, e.g., 256*256 pixels, 512*512 pixels, etc. Alternatively, the image may be broken down into multiple tiles with different sizes. For example, tiles in each row of FIG. 2 may have different lengths and tiles in each column of FIG. 2 may have different widths.

After breaking down the image into multiple tiles, the method 4000 of FIG. 4 may optionally include pre-processing of respective tiles of the multiple tiles such as noise filtering, etc. (not shown in FIG. 4).

Block 4300: processing the multiple tiles using an instance segmentation algorithm, to obtain respective instance boundaries for the plurality of instances of the object.

For example, multiple forward passes through the instance segmentation algorithm may be executed sequentially or at least partly contemporaneously using parallel processing. Each forward pass processes a respective tile or a batch of tiles.

Advantages of tile-wise processing are memory efficiency and the ability to process multiple tiles in parallel, e.g., using GPUs or TPUs.

According to this disclosure, any existing instance segmentation algorithm can be utilized for processing the multiple tiles of the image to obtain instance boundaries within the multiple tiles. Each forward pass of the instance segmentation algorithm may output a respective segmentation map including a collection of instance boundaries. The instance boundaries may also be output in another data format.

For example, the 18 tiles of the image 2000 of FIG. 2 may be respectively processed using a trained instance segmentation algorithm to obtain respective instance segmentation maps of the 18 tiles, i.e., 18 instance segmentation maps. Respective instance boundaries for the multiple instances of the object, i.e., the oval shapes, can be obtained in the respective instance segmentation maps.

Instance boundaries can be formed by curves, splines or other 1-D extended structures delineating the outer circumference of each object instance. Instance boundaries accordingly surround a respective area of the image. A further option performing instance boundaries are segmentation maps. In a segmentation map, each pixel of the respective tile or image is assigned to a certain instance. Yet a further example bounding boxes.

According to various examples, the method 4000 may optionally comprise determining, based on the obtained respective instance boundaries for the plurality of instances of the object, the pairs of neighboring tiles in which at least one instance boundary is truncated by the border of a tile of the respective pair.

For example, referring to FIG. 2, since no instance boundary is truncated by borders of tiles of the pair [tile (w1, I1), tile (w1, I2)], such a pair of tiles may not be taken into account when performing block 4400 of the method 4000 to save computing time and resources.

I.e., only some overlap regions are considered that require attention as part of the merging strategy.

Block 4400 (overlap handling): for each of the pairs of neighboring tiles and for each instance boundary truncated by a border of a tile of the respective pair (as explained above): either merging or not merging (selectively merging) the respective instance boundary truncated by the border of the tile with a further instance boundary positioned in a further tile of the respective pair, depending on an overlap degree between the respective instance boundary truncated by the border of the tile and the further instance boundary.

The overlap degree may be a measure of how well two instance boundaries conform with each other. The overlap degree, accordingly, is indicative of a conformity between two instances arranged approximately at the same image position but processed in different forward passes of the instance segmentation algorithm (processing neighboring tiles).

As a general rule, the overlap degree can be determined based on an appropriate overlap metric. The overlap metric may be determined based on respective fractions of the instances located in respective overlap regions of pairs of neighboring tiles. For instance, a shape-based metric can consider the shape of curves delineating the circumference of the respective instances. For instance, an area-based metric can consider the size of the respective instance. For instance, a position-based metric can consider whether the respective instances are located at similar image positions. Combinations of such metrics are possible.

Referring to FIG. 3, after performing instance segmentation of the first tile 3100 using an available or existing instance segmentation algorithm, respective instance boundaries for the plurality of instances of the object, i.e., the boundaries of the entire or partial oval shapes filled with dotted pattern, are obtained. For example, a respective entire or partial boundary of the instances 3301, 3302, and 3303 can be obtained by processing the first tile 3100. Similarly, a further respective entire or partial boundary of the instances 3301, 3302, and 3303 can be obtained by processing the second tile 3100.

Since the instances 3301, 3302, and 3303 are located in the overlap region 3300 of the first tile 3100 and the second tile 3200, the respective entire or partial boundary of the instances 3301, 3302, and 3303 obtained from processing the first tile 3100 and the further respective entire or partial boundary of the instances 3301, 3302, and 3303 obtained from processing the second tile 3200 respectively belong to the same instances 3301, 3302, and 3303 of the object. Accordingly, the respective instance boundaries can be merged together based on respective boundaries depicted in both segmentation maps of the first 3100 and second 3200 tiles of at least one instance of the instances 3301, 3302, and 3303. The segmentation map of the first tile 3100 and the segmentation map of the second tile 3200 can be merged together after merging the respective instance boundaries.

According to various examples, the method 4000 may further comprise determining a segmentation map of the entire image 2000. Such segmentation map then depicts the respective instance boundaries for the plurality of instances of the object based on said selectively merging for each of the pairs of neighboring tiles of the multiple tiles (after overlap handling). The instance boundaries can be superimposed onto the original image.

In another variant, automated post-processing of the segmentation map would be possible. Examples include instance counting (e.g., cell counting), determination of a fraction of an area covered by instances of an object, e.g., cell confluency determination. When processing images depicting, e.g., semiconductor structures, defects can be detected. Residential areas may be highlighted in satellite images. These are only some specific examples of the myriad of possible examples of postprocessing accurate segmentation maps obtained from the disclosed techniques.

As will be appreciated from the above, the merging strategy relies on the overlap degree. Details with respect to possible implementations of the overlap degree will be explained hereinafter.

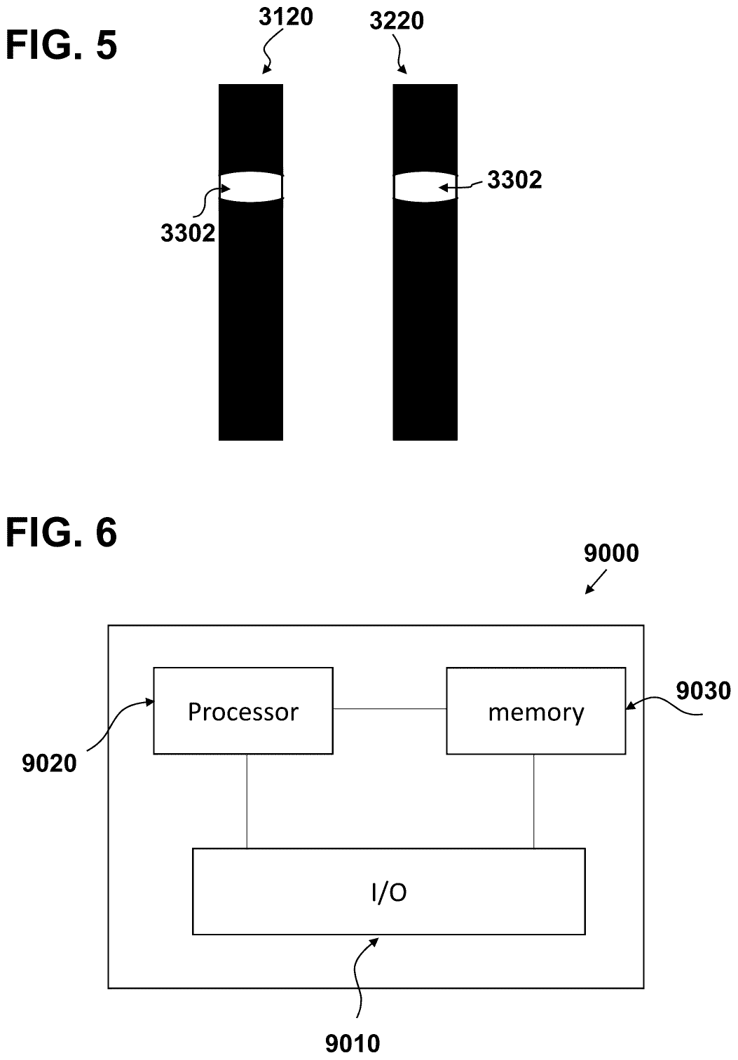

FIG. 5 relates to aspects of the overlap degree. FIG. 5 schematically illustrates two binary masks 3120 and 3220 of the overlap region 3300 of the pair 3000 of neighboring tiles of FIG. 3. The first binary mask 3120 (as an example of an instance boundary) may be obtained based on the instance segmentation map of the first tile 3100 after removing instance segmentations of the other two instances 3301 and 3303. Similarly, the second binary mask 3220 may be obtained based on the instance segmentation map of the second tile 3200 after removing instance segmentations of the other two instances 3301 and 3303. For both the first 3120 and the second 3220 binary masks, pixels which belong to the instance 3302 is true, i.e., “1”, and pixels which do not belong to the instance 3302 is false, i.e., “0”. For the instance 3302 of the object, the overlap degree between the first instance boundary truncated by the first border 3110 of the first tile 3100 and the second instance boundary truncated by the second border 3210 of the second tile 3200 can be calculated or determined according to the following formula:

$$Overlap degree = \frac{SUM ( AND ( the first binary mask , the second binary mask ) )}{SUM ( OR ( the first binary mask , the second binary mask ) )} \qquad ( 1 )$$

in which, the first 3120 and the second 3220 binary masks can be respectively regarded as two matrices; “AND” and “OR” are element-wise or entry-wise Boolean operations; “SUM” indicates an element-wise or entry-wise sum of a matrix.

Note that this is only one example of a metric used to calculate the overlap degree, and other overlap metrics are conceivable.

In the example above, the overlap degree is determined within the respective overlap region 330 of the tile and the further tile of the respective pair. I.e., parts of the instances of an object outside of the overlap region are disregarded when determining the overlap degree. Note that the instance extends away from the overlap region into the two tiles.

By considering the overlap degree—e.g., in accordance with the definition provided above by Equation 1—an accurate decision can be made whether certain instance boundaries belong to the same instance or different instances. Merging an instance of an object with an artifact instance boundary can be avoided. Merging instance boundaries belonging to different instances can be avoided.

As a general rule, it would be possible to execute merging only for a sufficiently large overlap degree (here, “large overlap degree” means significant conformity of the instance boundaries obtained from processing the neighboring tiles in the respective metric; e.g., similar size, similar shape of the contours, and/or similar pixels covered by the instance boundaries). A threshold comparison can be implemented. If the overlap degree is not sufficiently large, one of the two instances may be retained and the other instance may be discarded. For determining which of the two instances is to be discarded and which of the two instances is to be retained, different strategies can be employed. For example, it would be possible to consider a confidence of the prediction of the instance segmentation algorithm associated with each of the two instances.

In some examples, a multi-threshold comparison of the overlap degree can be implemented. An example is explained below. After determining or calculating the overlap degree, the method 4000 may comprise comparing the overlap degree with a first predefined threshold, e.g., within the range in the range of 70% to 100%. According to various examples, said selectively merging may comprise upon determining that the overlap degree is above a first predefined threshold: merging the respective instance boundary truncated by the border of the tile and the further instance boundary.

For example, referring to FIG. 5, for the instance 3302, if the overlap degree between the first instance boundary truncated by the first border 3110 of the first tile 3100 and the second instance boundary positioned in the second tile 3200 is above the first predefined threshold, the first instance boundary truncated by the first border 3110 of the first tile 3100 and the second instance boundary positioned in the second tile 3200 are merged. This is because the two instances correspond closely with each other. Accordingly, a smooth transition of instance boundaries (or contours) of the object between neighboring tiles can be facilitated.

If the overlap degree is below the first predefined threshold, the method 4000 may comprise comparing the overlap degree with a second predefined threshold, e.g., any one of 20%-40%. Said selectively merging may comprise upon determining that the overlap degree is below the first predefined threshold but is above the second predefined threshold: determining respective confidence values for the respective instance boundary truncated by the border of the tile and the further instance boundary and removing, from the respective instance boundary truncated by the border of the tile and the further instance boundary, an instance boundary which has a lower confidence values.

For example, referring to FIG. 3, the first border 3110 of the first tile 3100 truncates the instance boundary of the instance 3303, and accordingly a part of the instance boundary of the instance 3303 is located in the first tile 3100. A further instance boundary of the instance 3303, i.e., the entire instance boundary of the instance 3303, is positioned in the second tile 3200 of the pair 3000. The respective confidence values or levels of both the instance boundary truncated by the first border 3110 of the first tile 3100 and the further instance boundary positioned in the second tile 3200 can be determined based on respective counts of pixels within the respective instance boundaries or respective areas of regions surrounded by the respective instance boundaries. According to various examples, the respective confidence values may be determined using existing techniques for analyzing predictions of an available instance segmentation algorithm.

As shown in FIG. 3, in the first tile 3100, the count of pixels within the instance boundary of the instance 3303 or the area of the region surrounded by the instance boundary of the instance 3303 is smaller or lower than that of the further instance boundary of the instance 3303 positioned in the second tile 3200. I.e., the further instance boundary of the instance 3303 positioned in the second tile 3200 may have a higher confidence value or level. As such, the instance boundary of the instance 3303 truncated by the first border 3110 of the first tile 3100 may be removed.

Alternatively, upon determining that the overlap degree is above the first predefined threshold, the method 4000 may comprise determining the respective instance of the object comprising the respective instance boundary and the further instance boundary as a candidate instance to be merged. Said selectively merging may be based on respective candidate instances.

According to various examples, after determining all candidate instances, the method 4000 may further comprise filtering out candidate instances which may produce artifacts after merging and removing such candidate instances. Said selectively merging may be based on respective remaining candidate instances after said removing.

These steps may be needed to account for respective instances of the object which may be merely detected in some tiles. The rationale is that the result may look more natural if an instance of the object is not detected at all, as compared to detecting instances of the object with unnatural artifacts in their boundaries or contours.

For example, referring to FIG. 3, if the overlap degree between the first instance boundary of the instance 3303 truncated by the first border 3110 of the first tile 3100 and the second instance boundary of the instance 3303 positioned in the second tile 3200 is below the first predefined threshold but above the second predefined threshold, the first instance boundary of the instance 3303 truncated by the first border 3110 of the first tile 3100 will be removed because the area of the region surrounded by the first instance boundary is smaller than that of the region surrounded by the second instance boundary which surrounds the entire instance 3303 of the object. As such, deletion or removal of instances of the object which accidentally overlap slightly can be avoided and meanwhile discontinuities of instance boundaries of the object can be avoided or improved after merging.

Such techniques are based on the finding that if one instance boundary is truncated by a border of a tile and without merging across the border of the tile with a further instance boundary positioned in a further tile neighboring to the tile, such an instance boundary is likely an artifact at the tile border. This artifact might come from the instance segmentation algorithm's “hallucinating” since it has very little image context to make an accurate prediction in a respective region. Thus, it can safely be removed. Then, discarding the instance boundary that is truncated by a border of the tile (the border of the tile also corresponds to the border of the overlap region) typically yields better results. This is based on the assumption that the instance of the object extends beyond the boundary of the tile into the other tile of the pair of neighboring tiles and is thus more accurately captured by the respective instance boundary obtained by processing the other tile.

Despite such sophisticated logic for determining whether or not to merge overlapping instance boundaries, it has been observed that sometimes artifacts can be produced when merging instances of an object that overlap across overlap regions. Therefore, post-processing can be used to remove such artifacts after the overlap handling is complete.

According to various examples, the method 4000 may further comprise upon determining that one or more artifacts are produced after said merging of the respective instance boundary truncated by the border of the tile and the further instance boundary: removing the respective instance boundary truncated by the border of the tile.

According to various examples, the method 4000 may further comprise for each instance boundary truncated by the border of the tile of the respective pair, determining a confidence value or level; for each of the pairs of neighboring tiles, selecting at least one instance boundary with the highest confidence value, and said selectively merging is further based on the selected at least one instance boundary.

For example, referring to FIG. 3, the first border 3110 of the first tile 3100 respectively truncates both instance boundaries of the instances 3302 and 3303. The respective confidence values or levels of both instance boundaries of the instances 3302 and 3303 can be determined based on a trustworthiness of the instance segmentation algorithm output; for instance, for classification tasks it is possible to provide a trustworthiness of the classification prediction based on a distribution of multiple output neurons of the output layer (corresponding to different object types or background) for a given pixel. In case of similar output probabilities in multiple output neurons, the trustworthiness is typically low. On the other hand, for significantly differing neuron values at the output layer, the trustworthiness is oftentimes high. There are also secondary algorithms available to judge the trustworthiness of a prediction of another algorithm which may be employed in the disclosed example. Yet another measure for the trustworthiness is the respective counts of pixels within the respective instance boundaries or respective areas of regions surrounded by the respective instance boundaries. For example, small instance segmentations are oftentimes less trustworthy than extended and large instance boundaries.

As shown in FIG. 3, in the first tile 3100, the count of pixels within the instance boundary of the instance 3302 or the area of the region surrounded by the instance boundary of the instance 3302 is larger than that of the instance 3303. I.e., the instance boundary of the instance 3302 may have a higher confidence value or level. As such, the instance boundary of the instance 3302 may be selected and said selectively merging may be based on the instance boundary of the instance 3302.

In other words, a priority order between multiple instance boundaries obtained from the instance segmentation algorithm can be defined. The priority order is based on the confidence values or levels associated with each instance boundary. Different metrics for determining confidence values or level are conceivable including, as explained above, a pixel count or an analysis of the trustworthiness of the inference provided by the instance segmentation algorithm.

Then, instance boundaries having a higher priority may be favored, e.g., less likely to be discarded in case of a limited overlap degree or weighted higher when merging with another instance boundary.

FIG. 6 is a block diagram of a computing device 9000 according to various examples. The computing device 9000 may comprise a processor 9020, a memory 9030, and an input/output interface 9010. The processor 9020 is configured to load program code from the memory 9030 and execute the program code. Upon executing the program code, the processor 9020 performs the method 4000 for processing an image depicting a plurality of instances of an object, e.g., a microscopy image depicting a plurality of instances of muscle cells.

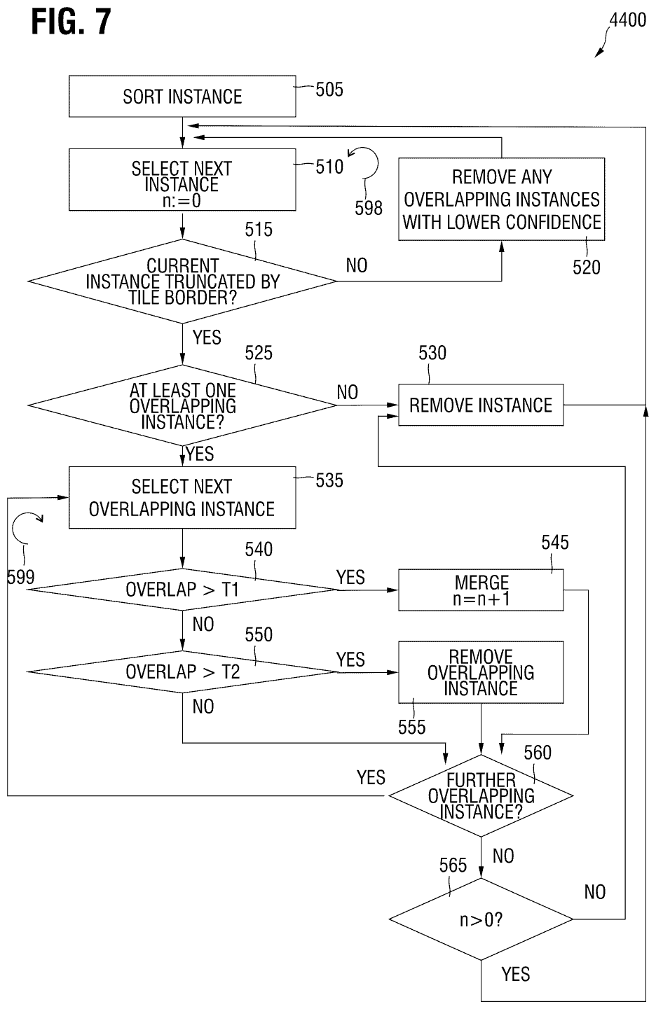

The computing device 9000 may be embedded in or connected with a tissue analyzer or microscopy. I.e., the tissue analyzer or microscopy comprising the computing device 9000 may be configured to perform the method 4000. The computing device 9000 may execute the method of FIG. 7.

FIG. 7 is a flowchart of a method according to various examples. The method can be executed by at least one circuit, such as a CPU and/or GPU and/or TPU, upon loading program code from non-volatile memory. The method facilitates instance segmentation of large images, such as microscopy images or satellite images.

The method of FIG. 7 is a concrete implementation example of the general method of FIG. 4. Specifically, the method of FIG. 7 is an example implementation of block 4400.

Block 505: Initially, all instance boundaries obtained from the multiple forward passes of the instance segmentation algorithm (for each tile) are sorted. I.e., the results of all forward passes are consolidated.

Such sorting can define a priority order. The sorting may be based on confidence values. Various metrics are available for determining the confidence values, including a number of pixels covered by the respective instance boundary or a trustworthiness of the respective prediction of the instance segmentation algorithm.

Block 510: the next instance boundary is selected in accordance with the priority order, i.e., from high priority to low priority. Also, an integer variable n is set to 0. Block 510 defines an outer loop 598 that iterates through the instance boundaries from high priority to low priority.

Block 515: it is checked whether the currently selected instance boundaries truncated by a tile border.

If the current instance boundary is not truncated by a tile border, the method commences at block 520. Then, any lower priority instance boundary having any overlap with the current instance boundary and being lower in priority are removed before a further iteration of block 510 is executed.

Block 515 in combination with block 520 pre-filters cases in which the merging strategy does not need to take into account truncation of the instance boundary by a tile border. This equates to determining the pairs of neighboring tiles in which at least one instance boundary is truncated by the board of a tile of the respective pair. By discarding one instance boundary having a smaller confidence value of the current instance boundary and the further instance boundary in the other tile at block 520, the more accurate instance boundaries prevail.

Next, the case is discussed in which the current instance boundary is truncated by a tile border. Then, the method commences at block 525.

Block 525: here, it is determined whether the current instance boundary (truncated by a title border) at least partly overlaps with a further instance boundary. Such partly overlapping may require a minimum overlap degree. If there is no overlapping instance boundary, it can be judged that the current instance boundary is likely an artifact and, accordingly, removed at block 530 before a further iteration of block 510 commences.

The “Yes”-output of block 525 thus is visited by each of pairs of neighboring tiles and for each instance boundary that is truncated by a border of the respective tile and has one or more overlapping instance boundaries. The “Yes”-output triggers one or more iterations of an inner loop 599. One or more iterations of the inner loop 599 are executed for each iteration of the output loop 598.

By using the inner loop 599 and the outer loop 598 depending on the priority order, the merging is based on the confidence value or level associated with the instance boundaries.

At block 535, the next one of the one or more overlapping instance boundaries is selected.

Blocks 540, 550: A multi-threshold comparison—here including two threshold T1, T2—is implemented. T1>T2. The multi-threshold comparison facilitates selective merging of the current instance boundary selected at block 510 and the current overlapping instance boundary 535 depending on their overlap degree.

Block 540: Upon determining that the overlap degree is above the threshold T1, the method commences at block 545 with merging the two instance boundary selected in the current iteration of blocks 510 and 535. The integer variable n is incremented once. The method then commences at block 560.

Block 550: upon determining that the overlap degree is below the threshold T1 and is above the threshold T2, the lower-priority instance boundary (e.g., having a lower confidence value) is removed at block 555. The method then commences at block 560.

If the overlap degree is even below the threshold T2, no action is taken (no merging, no removal). The method then commences at block 560.

Block 560: it is determined whether there is a further instance boundary overlapping with the current instance boundary selected at block 510 and having a lower priority than the current instance boundary selected at block 510 and not previously processed in the current iteration of the outer loop 598. In the affirmative, a further iteration of block 535 is executed; i.e., a further iteration of the inner loop 599 within the current iteration of the outer loop 598. Else, the method commences at block 565, leading towards a further iteration of the outer loop 598.

Block 565: it is determined whether the integer variable and is larger than 0, i.e., whether one or more merges of the current instance boundary of the current iteration of the outer loop 598 have been executed by one or more iterations of block 545. If this is not the case, the current instance boundary selected at the current iteration of block 510 is removed/discarded at block 530 before a further iteration of block 510 commences. Otherwise, the current instance boundary selected at the current iteration of block 510 is retained and a further iteration of block 510 commences.

A further iteration of the outer loop 598 Thus commences.

Once there is no further current instance boundary to be processed in a further iteration of the outer loop 598, artifact filtering may be executed (not shown in FIG. 7). Here, additional instance boundaries can be removed that likely contain artifacts. Finally an instance map depicting all instance boundaries superimposed onto the original image can be generated.

FIG. 7 is only an example. Various modifications are conceivable. For instance, in the example of FIG. 7 an overlap degree is used only for the “Yes”-branch of box 515, i.e., for instances that are truncated by a tile border. It would be—alternatively or additionally—possible to use an overlap degree for the “No”-branch of box 515. It would be possible to selectively merge or discard any overlapping instances depending on the overlap degree, e.g., using a multi-threshold comparison as explained above in connection with box 540 and box 550. For instance, if the overlap degree is above a (larger) first threshold, two instances may be merged; if the overlap degree is below a (smaller) second threshold, one of the two instances may be discarded, etc.

Summarizing, techniques have been described that facilitate determining instance segmentation of a large-size image. The techniques allow for processing images depicting multiple instances of objects of any size, i.e., not only objects smaller than the width or length of respective overlap regions but also objects larger than the width or length of the respective overlap regions. Accordingly, the techniques disclosed herein can facilitate precise and reliable determination of a segmentation map of an entire image. An overlap-handling process for processing overlap regions of between neighboring tiles of a tiled image has been disclosed. The overlap-handling process includes determining an overlap degree between a first instance boundary associated with a first tile and a second instance boundary associated with a second tile that are both at least partly arranged in a respective overlap region of the first tile and the second tile. The overlap-handling process also includes, depending on the overlap degree, selecting at least between merging the first instance boundary and the second instance boundary and removing one of the first instance boundary and the second instance boundary. At least one of the first instance boundary and the second boundary may be truncated by a border of the first tile or the second tile. If the one of the first and second instance boundaries is removed, this is the one being associated with a smaller confidence value.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustrative purposes, above multiple approaches using multi-threshold comparisons to determine whether to merge two overlapping instances of an object or rather discard one of the two overlapping instances have been employed. It would be likewise possible to employ a single-threshold comparison where two instances are either merged or one is discarded depending on the overlap degree being larger or smaller than a single threshold.

What is claimed is:

1. A computer-implemented method, comprising:
obtaining an image depicting a plurality of instances of an object;
breaking down the image into multiple tiles, wherein pairs of neighboring tiles of the multiple tiles comprise respective overlap regions;
processing the multiple tiles using an instance segmentation algorithm, to obtain respective instance boundaries for the plurality of instances of the object; and
for each of the pairs of neighboring tiles and for each instance boundary truncated by a border of a tile of the respective pair: selectively merging the respective instance boundary truncated by the border of the tile with a further instance boundary positioned in a further tile of the respective pair depending on an overlap degree between the respective instance boundary truncated by the border of the tile and the further instance boundary.

2. The computer-implemented method of claim 1, wherein said selectively merging comprises:
upon determining that the overlap degree is above a first predefined threshold: merging the respective instance boundary truncated by the border of the tile and the further instance boundary.

3. The computer-implemented method of claim 1, wherein said selectively merging comprises:
upon determining that the overlap degree is below a first predefined threshold and is above a second predefined threshold: selecting either the respective instance boundary truncated by the border of the tile or the further instance boundary, and removing the selected one of the of the respective instance boundary truncated by the border of the tile and the further instance boundary.

4. The computer-implemented method of claim 3, wherein said selectively merging comprises:
determining a first confidence value associated with the respective instance boundary truncated by the border of the tile and determining a second confidence value associated with the further instance boundary,
wherein said selecting of either the respective instance boundary truncated by the border of the tile or the further instance boundary is based on a comparison of the first confidence value and the second confidence value.

5. The computer-implemented method of claim 1, further comprising:
upon determining that one or more artifacts are produced after said merging of the respective instance boundary truncated by the border of the tile and the further instance boundary: removing the respective merged instance boundary truncated by the border of tiles.

6. The computer-implemented method of claim 1, further comprising:
determining, based on the instance boundaries for the plurality of instances of the object, the pairs of neighboring tiles in which at least one instance boundary is truncated by the border of a tile of the respective pair.

7. The computer-implemented method of claim 1, wherein the overlap degree is determined within the respective overlap region of the tile and the further tile of the respective pair.

8. The computer-implemented method of claim 1, further comprising:
for each instance boundary truncated by the border of the tile of the respective pair: determining a confidence value;
for each of the pairs of neighboring tiles: selecting at least one instance boundary with the highest confidence value;
wherein said selectively merging is further based on the selected at least one instance boundary.

9. The computer-implemented method of claim 1, wherein the image is a microscopy image or a satellite image.

10. A computing device, the device comprising a processor and a memory, wherein upon loading and executing program code from the memory, the processor is configured to perform the method of claim 1.
